(19) United States
(12) Patent Application Publication
(10) Pub. No.: US 2004/0253063 A1
(43) Pub. Date: Dec. 16, 2004

(54) Cutting tool insert and cutter body

(75) Inventor: Roger A. Murrell, Shelby Township, MI (US)

Correspondence Address: JAMES D. STEVENS, REISING, ETHINGTON, BARNES, KISSELLE, P.C., P.O. BOX 4390, TROY, MI, 48099, US

(73) Assignee: Arm Tooling, Inc., Warren, MI

(21) Appl. No.: 10/856,061

(22) Filed: May 28, 2004

Related U.S. Application Data
(60) Provisional application No. 60/474,112, filed on May 29, 2003.

(51) Int. Cl. B23C 5/00

(52) U.S. Cl. 407/113

(57) ABSTRACT

A cutting tool having a plurality of cutting inserts mounted about the periphery of a cutter body. The insert has radially extending projections each including a front cutting edge and rear cutting edge. Front and rear cutting edges from different adjacent projections together define an individual cutting side of the insert. The cutter body has a pocket for each insert. The insert engages the pocket side wall at multiple locations using only the front teeth from two or more projections. This permits a single cutter body and pocket design to be used with different inserts and allows the inserts' radial rake angle to be varied from one insert to the next by varying the front tooth height.

### CROSS-REFERENCE TO RELATED APPLICATION

This application claims the priority of U.S. Application No. 60/474,112, filed May 29, 2003, the complete disclosure of which is hereby incorporated by reference.

### TECHNICAL FIELD

This invention relates generally to cutting tools, and more particularly to rotary cutting tools having cutting inserts mounted about the periphery of a cutter body.

### BACKGROUND OF THE INVENTION

Typically, machines for milling, turning, boring, and the like, have a rotating spindle that drives a cutter body for rotation. The cutter body includes one or more cutting inserts for machining material that are commonly constructed from carbide and may be coated depending on the material being machined. Typically, the cutting inserts are releasably attached to the cutter body about its periphery and can be removed from the cutter body when they become worn. Generally, when the inserts become worn, they are removed from the cutter body and discarded or reground and new inserts are installed on the cutter body. To maximize the useful life of an insert, it is known to provide a multi-sided insert having at least one cutting edge on two or more of the sides, as disclosed in U.S. Pat. No. 5,209,611. When the cutting edge on one side of the insert becomes worn, the insert can be repositioned to present an unused cutting edge in a cutting position.

### SUMMARY OF THE INVENTION

In accordance with one aspect of the invention there is provided a cutting tool insert which comprises an insert body having upper and lower surfaces with an opening passing through the body in an axial direction from the upper surface to the lower surface. The insert body includes a plurality of radially outwardly extending projections located at a periphery of the insert body between the upper and lower surfaces. Each of the projections has a pair of adjacent cutting edges, each of which is spaced circumferentially from the other by a recess extending inwardly toward the opening. The cutting edges and recesses each extend at least generally in the axial direction. Preferably, each of the pair of cutting edges includes a front cutting edge and a rear cutting edge, with the front and rear cutting edges being arranged in alternating sequence about the circumference of the insert such that one of the front cutting edges from one projection and one of the rear cutting edges on an adjacent projection together comprise a cutting side of the insert.

In accordance with another aspect of the invention, there is provided a cutting tool comprising (i) a cutter body having a plurality of pockets located about its periphery, (ii) a plurality of cutting inserts, and (iii) a plurality of fasteners attaching each insert within one of the pockets. Each insert has a number of cutting sides, each of which has a front cutting tooth and a rear cutting tooth. The pockets in the cutter body are each defined at least in part by a recessed surface and side wall which is complementary in shape to the inserts. Each pocket can receive one of the inserts such that two of the front teeth of the insert abut the side wall of the pocket with at least one interposed rear tooth that is spaced from the side wall. This arrangement permits a single pocket design to accommodate different inserts with different front tooth heights so that the radial rake angle of the teeth can be varied from one application to the next using the same cutter body.

### BRIEF DESCRIPTION OF THE DRAWINGS

A preferred exemplary embodiment of the invention will hereinafter be described in conjunction with the appended drawings, wherein like designations denote like elements, and wherein:

FIG. 1 is a front view of a cutting tool having a cutter body and cutting inserts attached thereto and;

FIG. 2 is a side view of the cutting tool of FIG. 1 showing some of the inserts and their corresponding pockets within the cutter body;

FIG. 3 is a rear view of the cutting tool of FIG. 1;

FIG. 4 is a perspective view of one of the cutting inserts of FIG.1;

FIG. 5 is a plan view of the cutting insert of FIG. 4;

FIG. 6 is a side view of the cutting insert of FIG. 4;

FIG. 7 is an enlarged fragmentary view of one of the inserts shown properly oriented and assembled in a pocket of the cutter body of FIG. 1; and

FIG. 8 is a view similar to FIG. 7 with an insert shown improperly oriented in a pocket of the cutter body of FIG. 1.

### DESCRIPTION OF THE PREFERRED EMBODIMENT

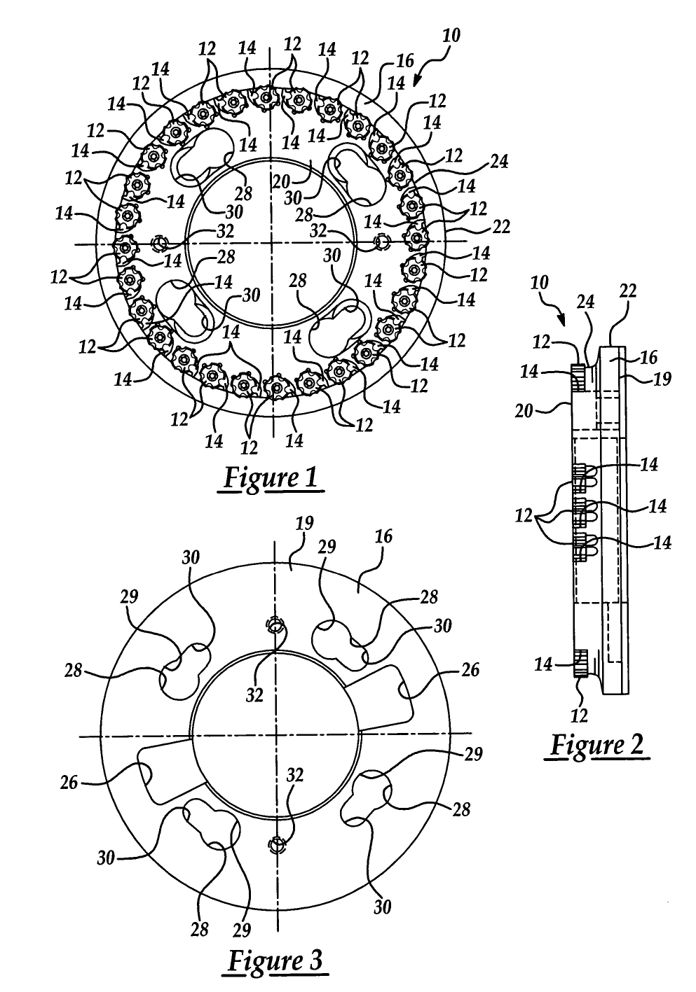

Referring in more detail to the drawings, FIGS. 1 and 2 illustrate a cutting tool 10 that includes a cutter body 16 and a plurality of cutting inserts 12 mounted within complementary pockets 14 provided adjacent to a periphery 22 of the cutter body 16. As will be described in greater detail below, the cutting inserts 12 and the pockets 14 are shaped such that the inserts 12 may only be assembled within the pockets 14 while in their proper orientation. As will be described further below in connection with FIG. 8, if the inserts 12 are inserted within the pockets 14 in an improper orientation, such as inverted or upside down, the inserts 12 cannot be fully received or secured within the pockets 14. This ensures that cutting features on each insert are properly oriented relative to a workpiece to be machined.

As shown in FIG. 2, the cutter body 16 has first and second sides or faces 19, 20 extending to the periphery 22 which, in the embodiment shown, has a necked down or reduced diameter portion 24. As best shown in FIG. 3, the back side 19 is constructed for attachment to a spindle of a machine (not shown). This side 19 preferably has at least one, and shown here as a pair of keyways 26 formed in its surface. The keyways 26 receive keys extending from the spindle to connect the cutter body 16 with the spindle. For mounting purposes, the cutter body 16 has a plurality of slotted openings 28 passing therethrough. The slotted openings 28 have enlarged portions 29 enabling the cutter body to fit over the heads of fasteners attached to the spindle (not shown), and narrow portions 30 so that the cutter body 16 can be rotated to dispose the shank of the fasteners in the narrow portions 30 of each opening 28 with the cutter body 16 trapped between the enlarged fastener heads and the spindle. It should be recognized that the narrow portions 30 are preferably recessed within the front side 20 so that the heads of the fasteners securing the cutter body 16 to the spindle are not unduly projected from and may be flush with the face 20. As is known, the cutter body 16 has at least one and shown here as a pair of threaded openings 32 to facilitate removal of the cutter body 16 from the spindle when desired.

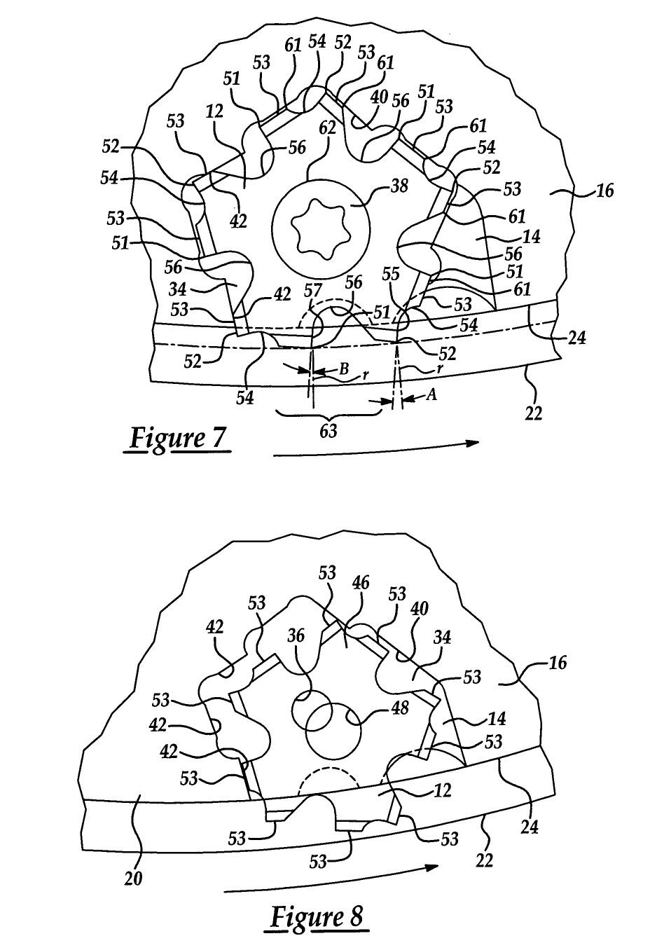

The pockets 14 are formed in one face 20 adjacent to the necked down portion 24 of the periphery 22 (FIGS. 1 and 2). As best shown in FIGS. 7 and 8, the pockets 14 are generally complementarily shaped to the cutting tool inserts 12, but slightly larger than the inserts 12 so that the inserts 12 may be received in the pockets 14. Each pocket 14 has a recessed surface 34 and a threaded blind bore 36. Preferably, the bore 36 is located within the pocket 14 so that when the cutting tool insert 12 is fully received within the pocket 14 it may be secured in the pocket 14 by way of a fastener 38. When secured in this manner, the insert 12 is assured of being in its proper orientation and not improperly installed within the pocket 14. In addition, a wall 40 defining at least in part the pocket 14 includes a plurality of surfaces 42 disposed at various orientations and distances relative to the bore 36 to closely receive adjacent portions of a cutting tool insert 12 when the insert 12 is properly orientated in the pocket.

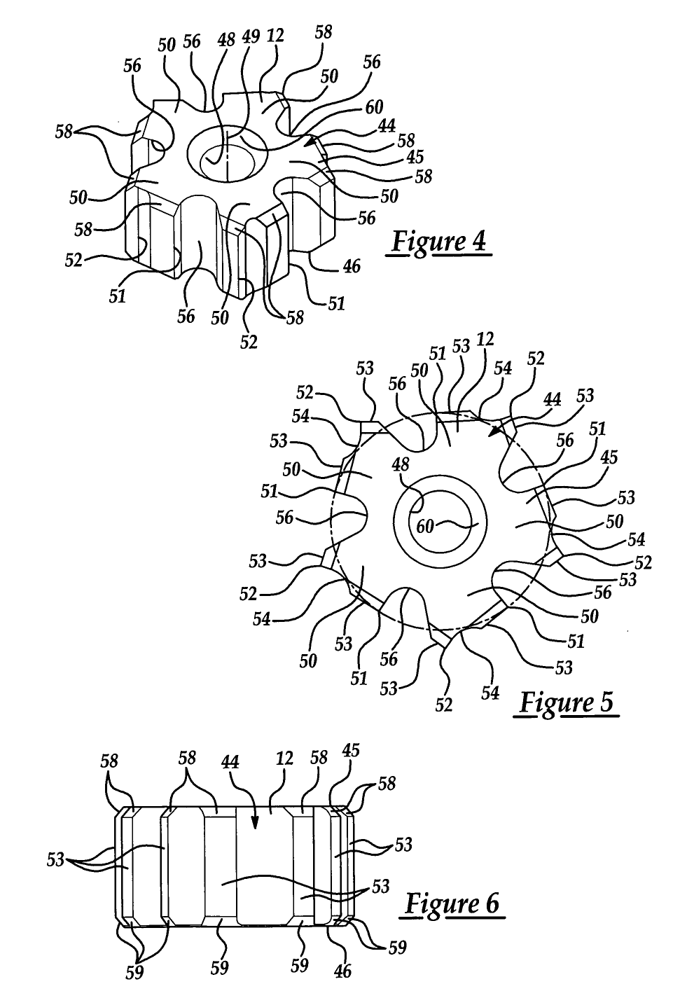

As shown in FIG. 4, the cutting tool insert 12 has an insert body 44 with upper and lower surfaces 45, 46 and a central opening or through hole 48 extending generally along an axis 49 of the body 44 from one face 45 to the other face 46. As best shown in FIG. 5, the insert body 44 has at least a pair and shown here as five radially outwardly extending projections 50 providing the cutting insert 12 with a generally pentagonal shape as viewed along the axis 49. Each projection 50 has a pair of respective separate rear and front cutting edges 51, 52 located at the leading edges of generally flat cutting teeth 53. Thus, each projection 50 includes a rear tooth 53 having a rear cutting edge 51, and a front tooth 53 having a front cutting edge 52. Adjacent teeth 53 on the same projection 50 are inclined relative to each other so that they are not parallel or mirror images of each other. A recess 54 preferably extends radially inwardly toward the opening 48 between the cutting edges 51, 52 of the same projection 50. The rear and front cutting edges 51, 52 extend generally axially and preferably lie within a plane that is parallel to the axis 49. The front cutting edges 52 and rear cutting edges 51 of the teeth 53 have a predefined radial rake angle (A and B, respectively) shown in FIG. 7. The rake angles A, B are defined by an included angle between a radius (r) of the cutter body 16 and respective projections of surfaces 55, 57 that extend radially inwardly from the outer surface of each front and rear tooth 53. Desirably, the front cutting edges 52 have a first rake angle (A) and the rear cutting edges 51 have a second rake angle (B) with the first rake angle A being more negative than the second rake angle B. As one example, the radial rake angle A can be −8.8° and radial rake angle B can be −4.9°.

The front cutting edges 52 extend radially outwardly from the center hole 48 of the insert farther than the rear cutting edges 51. This can be seen in FIG. 5 by the dashed circle that extends through the rear cutting edges 51 and which is located radially inwardly from the front cutting edges 52. Each projection 50 and its associated pair of cutting edges 51, 52 is circumferentially spaced from a pair of adjacent projections 50 and their associated cutting edges 51, 52 by recesses 56 extending radially inwardly toward the through hole 48. The recesses 56 separating each projection extend radially inwardly farther than the recesses 54 that separate the front and rear cutting edges of each projection 50. Each cutting edge 51, 52 extends generally between the faces 45, 46 of the insert 12 and preferably terminates at chamfers 58, 59, wherein the chamfers 58, 59 form a transition between the cutting edges 51, 52 and the faces 45, 46 (FIG. 6). Preferably, the through hole 48 has a countersunk chamfer 60 in one face 45 for receiving a mating head 62 of the fastener 38 so that the head 62 is generally flush with the face 45 of the insert body 44 upon assembly.

So constructed and arranged, the cutting insert has five potentially active cutting sides 63 that may be separately presented to machine a workpiece. Each active cutting side 63 includes two cutting teeth 53, and more particularly, an active cutting side 63 includes one rear cutting edge 51 from one projection 50 on one side of a recess 56 and another immediately adjacent front cutting edge 52 from another projection 50 on the other side of the same recess 56. In this embodiment, the cutting edges 51 and 52 on the same projection 50 are not part of the same active cutting side 63, and thus, do not coact to cut or machine a workpiece at the same time.

Even though the front cutting edges 52 extend radially beyond the other rear cutting edges 51 relative to the through hole 48 of the respective insert 12, the pockets 14 are oriented so that when a cutting tool insert 12 is properly positioned within a pocket 14, the cutting edges 51 and 52 of the exposed active cutting side 63 extend generally radially outwardly by the same distance relative to the reduced diameter portion 24 of the cutter body 16. As such, the active or working cutting side 63 presents one front cutting edge 52 and one rear cutting edge 51 on immediately adjacent projections 50 to perform the cutting action generally simultaneously, while the remaining cutting edges 51, 52 remain idle and in a non-cutting position. Once the active cutting edges 51, 52 become worn, the cutting edges 51, 52 in any of the non-cutting positions can be readily advance or rotated, as needed, to the active cutting position by removing the insert from its pocket, rotating it, and re-installing it into the pocket.

As shown in FIG. 7, when the cutting tool insert 12 is properly assembled within the generally complementary shaped pocket 14 of the cutter body 16, at least one and preferably a pair of the front teeth 53 abut a pair of complementary surfaces 42 within the pocket 14. Desirably, the pocket 14 is constructed relative to the insert 12 such that the two front teeth 53 immediately clockwise from the active cutting side will rest against two of the surfaces when the insert is fastened in place within the pocket. Accordingly, two of the pocket surfaces 42 most directly opposing the cutting forces imparted on the insert 12 are positioned to counteract the cutting forces, thereby positively maintaining the insert 12 in its mounted position against rotation or movement while in use. Accordingly, in addition to the fastener 38 securing the cutting tool insert 12 against movement within the pocket 14, the insert 12 is further inhibited from rotational or translational movement within the pocket 14 by the engagement of the front teeth against the surfaces 42 of the wall 40. It should be recognized that, although a pair of surfaces 42 are shown here engaging a pair of front teeth, more or fewer surfaces 42 could abut the front teeth.

While the insert 12 is arranged within the pocket 14 preferably by having a pair of front teeth in abutment with the surfaces 42 of the wall 40, the rear teeth containing rear cutting edge 51 remain spaced from the wall 40. This spacing of certain front and rear teeth 53 is represented generally at 61 for certain locations around in the insert (FIG. 7). As will be appreciated by those skilled in the art, spacing of the rear teeth from the pocket wall 40 allows the rake angles A, B of the insert 12 to be changed from one application to the next without having to modify the pockets 14 of the cutter body. More specifically, the rake angles A, B of the front and rear cutting edges 52, 51, can be set by adjusting the radial projection of the front teeth for a particular application. For example, the height (amount of protrusion) of the front teeth can all be reduced by an equal amount, thereby allowing the cutting insert 12 to rotate proportionately in a clockwise direction within its pocket 14 relative to that shown in FIG. 7, thereby altering and tending to decrease (i.e., increase negatively) the rake angles A, B. The rear teeth could also be adjusted accordingly so that both sets of teeth are aligned as desired along the cutting path shown by the dashed line in FIG. 7. Accordingly, depending on the application, the inserts 12 in combination with the pockets 14 provide a user with an ability to attain a more aggressive cutting attack by maintaining smaller rake angles A, B, thus requiring less overall horsepower to drive the cutting insert 14, or a less aggressive cutting attack by setting the rake angles A, B to a more negative value.

In the illustrated embodiment, two point contact is provided between the insert 12 and pocket wall 40, namely, the two front teeth located at the trailing side of the pocket 14, with the insert including an interposed rear tooth that is spaced from the wall 40. However, other arrangements and number of point contacts can be used while still permitting the amount of front tooth projection to affect the radial rake angles. Such variations and modifications with become apparent to those skilled in the art.

As shown in FIG. 8, if an attempt is made to install an inverted or upside down cutting tool insert 12 in a pocket 14 (i.e. with face 45 adjacent to the recessed surface 34), the outer surfaces of teeth 53 or cutting edges 51, 52 on certain projections 50 engage the wall 40 and/or some of the surfaces 42 before the insert 12 is fully received in the pocket 14. This occurs because the cutting edges 52 extend radially beyond and are inclined at different angles relative to the other cutting edges 51 whereby the circumferential positions of the cutting edges 52 change when the insert 12 is inverted. Because the insert 12 cannot be fully received in a pocket 14 when inverted, the hole 48 in the insert will not align with the bore 36 in the cutter body 16 so that the insert 12 cannot be secured in the pocket in this orientation. It should be recognized that though the cutting tool inserts 12 are shown here as having a generally pentagon shape, and thus having five projections 50 and five cutting sides, that any number of other geometries could be used, such as square, rectangular, triangular, hexagonal and the like. It should also be recognized that the pockets 14 within the cutter body 16 would take on a generally complementary geometry of the cutting tool inserts regardless of what their geometry might be.

It will thus be apparent that there has been provided in accordance with the present invention a cutting tool and cutting insert therefor which achieves the aims and advantages specified herein. It will of course be understood that the foregoing description is of a preferred exemplary embodiment of the invention and that the invention is not limited to the specific embodiment shown. Various changes and modifications will become apparent to those skilled in the art and all such variations and modifications are intended to come within the scope of the appended claims.

As used in this specification and appended claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A cutting tool insert, comprising an insert body having upper and lower surfaces with an opening passing through the body in an axial direction from said upper surface to said lower surface, said insert body including a plurality of radially outwardly extending projections located at a periphery of said insert body between said upper and lower surfaces, each of said projections having a pair of adjacent cutting edges each of which is spaced circumferentially from the other by a recess extending inwardly toward the opening, said cutting edges and said recesses each extending at least generally in the axial direction.

2. The insert of claim 1, wherein each of said pair of cutting edges comprises a front cutting edge and a rear cutting edge, said front and rear cutting edges being arranged in alternating sequence about the circumference of the insert with one of said front cutting edges from one projection and one of said rear cutting edges on an adjacent projection together comprising a cutting side of the insert, whereby said cutting side has two cutting edges arranged to cut material simultaneously.

3. The insert of claim 2, wherein said front cutting edges are located farther from said opening than said rear cutting edges.

4. The insert of claim 2, wherein said projections are separated by recesses that extend farther inwardly toward said opening than the recesses that separate said front and rear cutting edges from each other on each projection.

5. The insert of claim 1, wherein the body has a generally pentagonal shape.

6. The insert of claim 1, wherein each of said projections terminates in a pair of generally flat surfaces inclined relative to one another.

7. A cutting tool, comprising:
a plurality of cutting inserts each having upper and lower surfaces with an opening passing through the insert from said upper surface to said lower surface, each said insert including a plurality of radially outwardly extending projections located at a periphery of said insert between said upper and lower surfaces, each of said projections having front and rear cutting edges spaced circumferentially from each other by a recess extending inwardly toward the opening;
a cutter body having front and back sides and an outer periphery having a plurality of pockets, each of said pockets being defined at least in part by a side wall and a recessed surface having a bore; and
a plurality of fasteners each extending through one of said openings and said bores, thereby securing each said insert within its associated pocket;
each of said inserts abutting said side wall of said pocket at a location adjacent said front cutting edges on two of said projections and being spaced from said side wall at one or more locations adjacent said rear cutting edges of said two projections.

8. The cutting tool of claim 7, wherein said insert abuts said side wall only at two locations.

9. The cutting tool of claim 7, wherein said plurality of pockets comprises all of the pockets on said cutter body at its periphery and wherein said cutting tool includes one of said inserts for each of said pockets.

10. The cutting tool of claim 7, wherein said front and rear cutting edges are arranged in alternating sequence about the circumference of the insert with one of said front cutting edges from one projection and one of said rear cutting edges on an adjacent projection together comprising a cutting side of the insert, whereby said cutting side has two cutting edges arranged to cut material simultaneously.

11. The cutting tool of claim 10, wherein, for each cutting side of the insert, said front cutting edge has a radial rake angle A and said rear cutting edge has a radial rake angle B that is less negative than rake angle A.

12. A cutting tool, comprising:
a plurality of cutting inserts each having upper and lower surfaces with an opening passing through the body from said upper surface to said lower surface, said inserts further having a plurality of cutting sides located at a periphery of said insert between said upper and lower surfaces, said cutting sides each including a front cutting tooth and a rear cutting tooth; and
a cutter body having front and back sides and an outer periphery having a plurality of pockets, each of said pockets being defined at least in part by a recessed surface and side wall which is complementary in shape to said inserts such that each said pocket can receive one of said inserts, said recessed surface of each pocket having a bore that aligns with said opening of said insert to receive a fastener through said bore and said opening when said insert is positioned within said pocket;
said side walls of said pockets each having a conformation wherein, when each said insert is attached by a fastener within its associated pocket, two of said front teeth of said insert abut said side wall of said pocket with at least one interposed rear tooth being spaced from said side wall.

13. The cutting tool of claim 12, wherein only said two front teeth abut said side wall of said pocket.

14. The cutting tool of claim 12, wherein said plurality of pockets comprises all of the pockets on said cutter body at its periphery and wherein said cutting tool includes one of said inserts for each of said pockets.

15. The cutting tool of claim 12, wherein said front and rear teeth are arranged in alternating sequence about the circumference of the insert with one of said front teeth from one projection and one of said rear teeth on an adjacent projection together comprising a cutting side of the insert, whereby said cutting side has two teeth arranged to cut material simultaneously.

16. The cutting tool of claim 15, wherein, for each cutting side of the insert, said front tooth has a radial rake angle A and said rear tooth has a radial rake angle B that is less negative than rake angle A.

17. The cutting tool of claim 16, wherein the rake angles are dependent on the height of said front teeth.

18. The cutting tool of claim 12, wherein each insert has a generally pentagonal shape.
